(19) United States
(12) Patent Application Publication
(10) Pub. No.: US 2026/0313368 A1
(43) Pub. Date: Oct. 8, 2026

(54) PROTECTING USERS FROM UNWANTED TRACKING

(71) Applicant: Google LLC, Mountain View, CA (US)

(72) Inventors: Zachary Abraham Eddinger, San Francisco, CA (US); David Lazarov, Tel Aviv (IL); Siddika Parlak Polatkan, San Jose, CA (US); Shambavi Krishnamurthi, San Francisco, CA (US)

(21) Appl. No.: 19/482,146

(22) PCT Filed: May 30, 2024
(86) PCT No.: PCT/US2024/031767

§ 371 Date: Nov. 6, 2025

Related U.S. Application Data
(60) Provisional application No. 63/509,852, filed on Jun. 23, 2023.

(51) Int. Cl. H04W 12/02; H04W 4/021; H04W 4/029; H04W 12/03; H04W 12/63

(52) U.S. Cl. CPC H04W 12/02; H04W 4/021; H04W 4/029; H04W 12/03; H04W 12/63

(57) ABSTRACT

A method comprising detecting, by a computing device, a tracking device in proximity to the computing device. The method further includes determining, by the computing device, whether the tracking device is known to the computing device. The method further includes, responsive to determining that the tracking device is unknown to the computing device, sending, by the 2024/263360 computing device and to a remote computing system, a location report that includes a location of the tracking device. The method further includes receiving, by the computing device and from the remote computing system, a command to cause the tracking device to operate in an unwanted tracking prevention mode. The method further includes causing, by the computing device, the tracking device to operate in the unwanted tracking prevention mode by at least sending the command to the tracking device.

This application is a PCT with provisional priority of US Provisional Patent Application No. 63/509,852, filed 23 Jun. 2023, the entire contents of which is incorporated herein by reference.

### BACKGROUND

Low energy tracking devices may be used to track various other devices, objects, etc. using a crowd-source location system. The tracking devices may emit a low energy wireless signal that other devices may detect. The other devices may send the identifier of the tracking device and the location of the tracking device to a tracking device service provider. The owner of the tracking device may then receive the location of the tracking device from the service provider. However, such tracking devices may be small and the user of the other device that detected the tracking device may not be alerted that such a tracking device is nearby; as a result, the user may be unaware that the tracking device may is being used to track the user rather than an item owned by the owner of the tracking device.

### SUMMARY

In general, techniques of this disclosure enable a computing device to protect users from unwanted tracking by tracking devices. For example, a computing device associated with a user may detect that a tracking device not known by the computing device is within a threshold proximity of the computing device. The computing device reports the tracking device to a computing system that maintains records of tracking devices. The computing device may report a hashed public key of the tracking device to the computing system. The computing system may determine whether to alert the computing device regarding the tracking device, whether to report the location of the tracking device to the owner device of the tracking device, whether to place the tracking device in an unwanted tracking prevention mode, whether to limit location fetch requests for the tracking device from the owner device, and other actions regarding the tracking device. In this way, the techniques of this disclosure may provide various advantages, such as enabling a user to be alerted if they are being tracked with a tracking device and limiting the tracking of a tracker near an individual.

In some examples, a method includes detecting, by a computing device, a tracking device in proximity to the computing device, determining, by the computing device, whether the tracking device is known to the computing device, responsive to determining that the tracking device is unknown to the computing device, sending, by the computing device and to a remote computing system, a location report that includes a location of the tracking device, receiving, by the computing device and from the remote computing system, a command to cause the tracking device to operate in an unwanted tracking prevention mode, and causing, by the computing device, the tracking device to operate in the unwanted tracking prevention mode by at least sending the command to the tracking device.

In some examples, a computing device includes a memory. The computing device further includes one or more programmable processors in communication with the memory, and configured to detect a tracking device in proximity to the computing device, determine whether the tracking device is known to the computing device, responsive to determining that the tracking device is unknown to the computing device, send to a remote computing system, a location report that includes a location of the tracking device, receive, from the remote computing system, a command to cause the tracking device to operate in an unwanted tracking prevention mode, and cause the tracking device to operate in the unwanted tracking prevention mode by at least sending the command to the tracking device.

In some examples, a non-transitory computer-readable medium is encoded with instructions that, when executed by one or more processors of a computing device, cause the one or more processors to detect a tracking device in proximity to the computing device, determine whether the tracking device is known to the computing device, responsive to determining that the tracking device is unknown to the computing device, send to a remote computing system, a location report that includes a location of the tracking device, receive, from the remote computing system, a command to cause the tracking device to operate in an unwanted tracking prevention mode, and cause the tracking device to operate in the unwanted tracking prevention mode by at least sending the command to the tracking device.

In some examples, a computing system includes a memory. The computing system further includes one or more programmable processors in communication with the memory, and configured to receive an indication that a sighter device from a plurality of sighter devices has detected a tracking device unknown to the sighter device, wherein the sighter device is a computing device other than an owner device associated with the tracking device, determine whether to place the tracking device into a unwanted tracking prevention mode, and responsive to determining to place the tracking device into the unwanted tracking prevention mode, send, to the sighter device, a command to cause the tracking device to operate in the unwanted tracking prevention mode.

In some examples, a method includes receiving, by a computing system, an indication that a sighter device of a plurality of sighter devices has detected a tracking device unknown to the sighter device, wherein the sighter device is a computing device other than an owner device associated with the tracking device, determining, by the server and based on one or more factors, whether to place the tracking device into a unwanted tracking prevention mode, and responsive to determining to the place the tracking device into the unwanted tracking prevention mode, sending, by the server and to the tracking device, a command to cause the tracking device to transition into operating in the unwanted tracking prevention mode.

In some examples, a non-transitory computer-readable medium is encoded with instructions that, when executed, cause one or more processors to receive an indication that a sighter device from a plurality of sighter devices has detected a tracking device unknown to the sighter device, wherein the sighter device is a computing device other than an owner device associated with the tracking device, determine whether to place the tracking device into a unwanted tracking prevention mode, and responsive to determining to place the tracking device into the unwanted tracking prevention mode, send, to the sighter device, a command to cause the tracking device to operate in the unwanted tracking prevention mode.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example of a peer-to-peer device tracking service for protecting users from unwanted tracking, in accordance with one or more of the techniques described herein.

FIG. 2 is a block diagram illustrating an example computing device for protecting users from unwanted tracking, in accordance with one or more of the described techniques.

FIG. 3 is a block diagram illustrating an example computing system for protecting users from unwanted tracking, in accordance with one or more of the described techniques.

FIG. 4 is a flow chart illustrating an example operation on the peer-to-peer device tracking system for protecting users from unwanted tracking, in accordance with one or more of the techniques described herein.

### DETAILED DESCRIPTION

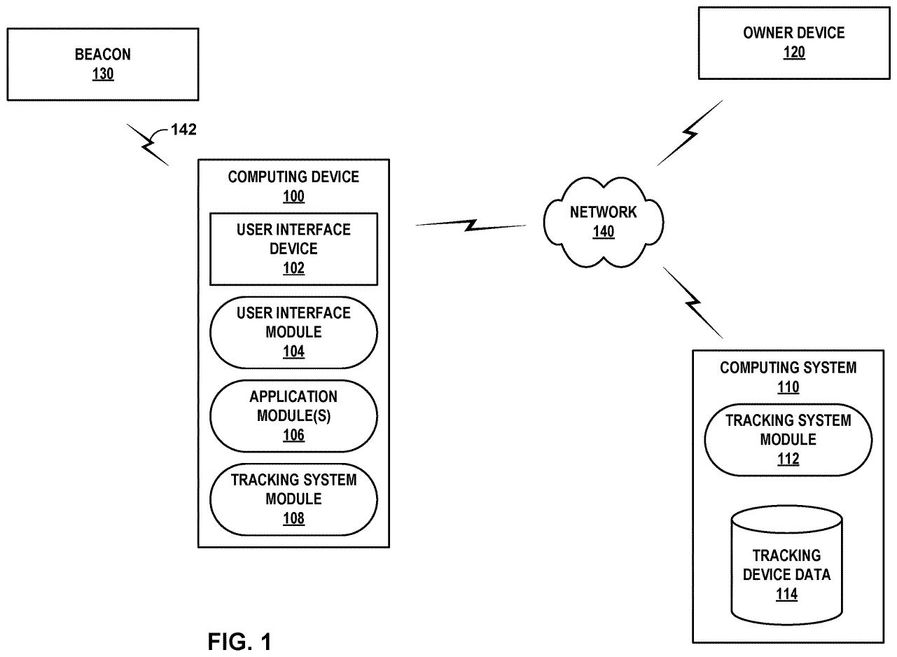

FIG. 1 is a block diagram illustrating an example of a peer-to-peer device tracking system for protecting users from unwanted tracking, in accordance with one or more of the techniques described herein. The peer-to-peer device tracking system illustrated in FIG. 1 includes computing device 100, computing system 110, owner device 120, and beacon 130 wherein computing device 100, computing system 110, and owner device 120 are communicatively coupled via network 140. In the examiner of FIG. 1, computing device 100 is communicatively coupled to beacon 130 via personal area network 142.

Beacon 130 represents a tracking device that communicates with computing devices such as computing device 100 to indicate the location of beacon 130. Beacon 130 may include one or more wireless radios for wireless communications such as BLUETOOTH, BLUETOOTH Low Energy (BLE), WIFI, ultra-wideband (UWB), among other types of wireless communications. Beacon 130 may communicate with computing devices such as computing device 100 via personal area network 142.

Beacon 130 may generate a static ID and rotating public keys. Beacon 130 may generate the rotating public keys and rotate to a new public key after a period of time has elapsed. For example, beacon 130 may rotate to a new public key every 10 minutes and broadcast the new public key to nearby computing devices such as computing device 100. Owner device 120 may use the static ID to register beacon 130 to owner device 120. Owner device 120 may register beacon 130 to associate beacon 130 with the user account of owner device 120. In some examples, beacon 130 may generate a rotating public ID.

Beacon 130 may enter an “unwanted tracking prevention mode” that includes changes to the operation of beacon 130. Beacon 130, while in the unwanted tracking prevention mode, may broadcast its position to nearby devices such as computing device 100. Beacon 130 may enter the “unwanted tracking prevention mode” in response to no longer being in proximity of a device associated with the owner of beacon 130 such as owner device 120. Beacon 130 may enter the unwanted tracking prevention mode in response to a command to enter the unwanted tracking prevention mode from computing system 110 that is relayed by computing device 100 via personal area network 142. Computing system 110 may send the command for beacon 130 to enter the unwanted tracking prevention mode based on a fetch location request from owner device 120.

Beacon 130 may enter an “unwanted tracking prevention mode” that includes changes to the operation of beacon 130. Further, limitations may be placed on the ability of owner device 120 to obtain the location of beacon 130 while in the unwanted tracking prevention mode. Beacon 130 may enter the unwanted tracking prevention mode in response to a device such as computing device 100 uploading the location of beacon 130 to computing system 110. Computing system 110, based on receiving the uploaded location of beacon 130 from computing device 100, may provide a command to computing device 100 to that is passed on to beacon 130 via personal area network 142 to enter the unwanted tracking prevention mode.

Beacon 130 may generate audio to assist in indicating the location of beacon 130. Beacon 130 may generate audio such as a beeping or ringing noise to aid in location beacon 130. Beacon 130 may generate the audio in response to a request by owner device 120 to generate audio. When not in unwanted tracking prevention mode (e.g., in a normal operating mode), beacon 130 may require the credentials of an owner device such as owner device 120 before generating audio. For example, beacon 130 may not allow computing device 100 to command beacon 130 to generate audio with the credentials of owner device 120 when in an operating mode other than the unwanted tracking prevention mode. When in the unwanted tracking prevention mode, beacon 130 does not require the credentials of an owner device such as owner device 120 to request the generation of audio. For example, while in unwanted tracking prevention mode beacon 130 allows computing device 100 to command beacon 130 to play audio without requiring any credentials or authentication of computing device 100 to beacon 130.

Beacon 130 may leave the unwanted tracking prevention mode once one or more conditions are met. Beacon 130 may leave the unwanted tracking prevention mode after it is detected by a device associated with the owner of beacon 130 such as owner device 120. Beacon 130 may leave the unwanted tracking prevention mode without a command from computing system 110 when it is detected by a computing device associated with the owner of beacon 130 such as owner device 120. Beacon 130 may leave the unwanted tracking prevention mode in response to a command from computing system 110. In an example, computing system 110 determines that beacon 130 no longer needs to be in the unwanted tracking prevention mode as one or more criteria have been met. Computing system 110 provides a command to beacon 130 to leave the unwanted tracking prevention mode.

Computing device 100 and owner device 120 each represent a mobile or non-mobile computing device. Examples of computing device 100 and owner device 120 include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); server computing devices (e.g., database servers, parameter servers, file servers, mail servers, print servers, web servers, game servers, application servers, etc.); dedicated, specialized model processing or training devices; virtual computing devices; other computing devices or computing infrastructure; or combinations thereof configured to send and receive information via a network, such as network 140.

As shown in FIG. 1, computing device 100 includes user interface device 102 (“UI device 102”), user interface module 104 (“UI module 104”), application module(s) 106, and tracking system module 108. UI device 102 of computing device 100 may be configured to function as an input device and/or an output device for computing device 100. UI device 102 may be implemented using various technologies. For instance, UI device 102 may be configured to receive input from a user through tactile, audio, and/or video feedback. Examples of input devices include a presence-sensitive or touch-sensitive input device (e.g., a presence-sensitive display), a mouse, a keyboard, a voice responsive system, video camera, microphone or any other type of device for detecting a command from a user. In some examples, a presence-sensitive display may include a touch-sensitive or presence-sensitive input screen, such as a resistive touchscreen, a surface acoustic wave touchscreen, a capacitive touchscreen, a projective capacitive touchscreen, a pressure sensitive screen, an acoustic pulse recognition touchscreen, or another presence-sensitive technology. That is, UI device 102 of computing device 100 may include a presence-sensitive device that may receive tactile input from a user of computing device 100. UI device 102 may receive indications of the tactile input by detecting one or more gestures from the user (e.g., when the user touches or points to one or more locations of UI device 102 with a finger or a stylus pen).

UI device 102 may additionally or alternatively be configured to function as an output device by providing output to a user using tactile, audio, or video stimuli. Examples of output devices include a sound card, a video graphics adapter card, or any of one or more display devices, such as a liquid crystal display (LCD), dot matrix display, light emitting diode (LED) display, microLED, miniLED, organic light-emitting diode (OLED) display, e-ink, or similar monochrome or color display capable of outputting visible information to a user of computing device 100. Additional examples of an output device include a speaker, a haptic device, or other device that can generate intelligible output to a user. For instance, UI device 102 may present output to a user of computing device 100 as a graphical user interface that may be associated with functionality provided by computing device 100. In this way, UI device 102 may present various user interfaces of applications executing at or accessible by computing device 100 (e.g., an electronic message application, an Internet browser application, etc.). A user of computing device 100 may interact with a respective user interface of an application to cause computing device 100 to perform operations relating to a function.

In some examples, UI device 102 of computing device 100 may detect two-dimensional and/or three-dimensional gestures as input from a user of computing device 100. For instance, a sensor of UI device 102 may detect the user's movement (e.g., moving a hand, an arm, a pen, a stylus, etc.) within a threshold distance of the sensor of UI device 102. UI device 102 may determine a two-or three-dimensional vector representation of the movement and correlate the vector representation to a gesture input (e.g., a hand-wave, a pinch, a clap, a pen stroke, etc.) that has multiple dimensions. In other words, UI device 102 may, in some examples, detect a multidimensional gesture without requiring the user to gesture at or near a screen or surface at which UI device 102 outputs information for display. Instead, UI device 102 may detect a multidimensional gesture performed at or near a sensor which may or may not be located near the screen or surface at which UI device 102 outputs information for display.

In the example of FIG. 1, computing device 100 includes user interface module 104, application module(s) 106, and tracking system module 108. Modules 104, 106, and 108 may perform operations described herein using hardware, software, firmware, or a mixture thereof residing in and/or executing at computing device 100. Computing device 100 may execute modules 104, 106, and 108 with one processor or with multiple processors. In some examples, computing device 100 may execute modules 104, 106, and 108 as a virtual machine executing on underlying hardware. Modules 104, 106, and 108 may execute as one or more services of an operating system or computing platform or may execute as one or more executable programs at an application layer of a computing platform.

UI module 104, as shown in the example of FIG. 1, may be operable by computing device 100 to perform one or more functions, such as receive input and send indications of such input to other components associated with computing device 100, such as application module 106. UI module 104 may also receive data from components associated with computing device 100 such as application module 106. Using the data received, UI module 104 may cause other components associated with computing device 100, such as UI device 102, to provide output based on the data. For instance, UI module 104 may receive data from one of application modules 106 to display a GUI.

Application modules 106, as shown in the example of FIG. 1, may include functionality to perform any variety of operations on computing device 100. For instance, application modules 106 may include a word processor, a text application, a web browser, a multimedia player, a calendar application, an operating system, a distributed computing application, a graphic design application, a video editing application, a web development application, or any other application. One or more of the application modules 106 may be a location app for locating various objects and tracking devices. For example, an application module of application modules 106 may include functionality to display the location of a user's devices such as a tablet or wireless earbuds, request an update to the location of one or more tracked devices and/or tracking devices, and share the location of the one or more tracked devices and/or tracking devices. Application modules 106, in various examples, may provide data to UI module 104 causing UI device 102 to display a GUI.

In some examples, one or more of application modules 106 may be operable to receive incoming communications from other devices (e.g., via network 140) such as computing system 110. For instance, one or more of application modules 106 may receive updates of a location of a tracking device for a tracking device associated with computing device 100 or other incoming communications. Additionally, one or more of application modules 106 may receive an alert regarding a tracking device such as beacon 130. Beacon 130 may represent one or more tracking devices. In addition, beacon 130 may be referred to herein as “tracking devices 130”.

In general, communications may include information (e.g., generated by computing system 110). Examples of information include text (e.g., any combination of letters, words, numbers, punctuation, etc.), location data, battery status, last-seen timestamps, indications of a device being lost or found, alerts, or any other content that may be included in a communication. In the example of FIG. 1, one of application modules 106 may receive an incoming communication (e.g., an alert about beacon 130) from another computing device (e.g., computing system 110).

Computing device 100 may communicate with and detect tracking devices such as beacon 130. Computing device 100 may detect that beacon 130 is within a predetermined proximity of computing device 100 using one or more ways of locating devices such using background BLUETOOTH scans or using BLUETOOTH Received Signal Strength Indicator (RSSI). Computing device 100 may detect beacon 130 and determine that beacon 130 is within a predetermined proximity of computing device 100 in response to establishing a connection with beacon 130 via personal area network 142 of computing device 100.

Computing device 100 may determine whether beacon 130 is known to computing device 100 or whether beacon 130 is an unknown tracking device to computing device 100. Computing device 100, based on a determination that beacon 130 is unknown to computing device 100, may report beacon 130 to computing system 110. Computing device 100 may determine, over a predetermined period of time, whether computing device 100 has repeatedly detected beacon 130. Responsive to determining that beacon 130 has been repeatedly detected nearby, computing device 100 may alert a user to the presence of beacon 130 within the proximity of computing device 100.

Computing device 100 may determine that beacon 130 is in an unwanted tracking prevention mode in one or more ways. In an example, beacon 130 is configured such that when it is no longer detected by owner device 120, beacon 130 ceases cycling MAC addresses or any other cycling broadcasted identifiers. Computing device 100, based on a determination that the MAC address of beacon 130 has remained constant over a period of time, determines that beacon 130 is in the unwanted tracking prevention mode. Additionally, beacon 130 may be configured to enter the unwanted tracking prevention mode in response to owner device 120 declaring that beacon 1340 is lost and requests end-to-end encrypted location reports for beacon 130. In another example, computing device 100 determines that beacon 130 is in the unwanted tracking prevention mode as beacon 130 is broadcasting a packet that includes a bit (e.g., a bit set to a value indicating whether beacon 130 is currently lost or found) indicating that beacon 130 has been separated from owner device 120.

Computing device 100 may generate an end-to-end encrypted location report in response to detecting beacon 130 within the proximity of computing device 100. Computing device 100 may generate an end-to-end encrypted location report that includes identifying information of beacon 130 such as a hashed public key of beacon 130 in addition to the end-to-end encrypted location of beacon 130 and a timestamp of when computing device 100 detected beacon 130.

Computing device 100 may provide the location report to computing system 110. Computing device 100 may provide an end-to-end encrypted location report to computing system 110 each time computing device 100 detects beacon 130 in proximity to computing device 100. Computing device 100 may limit how often computing device 100 provides an end-to-end encrypted location report to computing system 110 based on privacy settings of computing device 100. Computing device 100 may provide the end-to-end encrypted location report to computing system 110 via network 140.

Computing device 100, computing system 110, and owner device 120 may communicate with each other via network 140. Network 140 may include any public or private communication network, such as a cellular network, WIFI network, a direct cell-to-satellite communication network, or other type of network for transmitting data between computing devices. In some examples, network 140 may represent one or more packet switched networks, such as the Internet. Computing device 100, computing system 110, and owner device 120 may send and receive data across network 140 using any suitable communication techniques. For example, computing device 100, computing system 110, and owner device 120 may each be operatively coupled to the network using respective network links. The network may include network hubs, network switches, network routers, etc., that are operatively inter-coupled thereby providing for the exchange of information between computing device 100, computing system 110, and owner device 120. In some examples, network links of the network may be Ethernet, ATM or other network connections. Such connections may include wireless and/or wired connections. While illustrated as only including computing device 100, computing system 110, and owner device 120 as being connected to network 140, any number of devices may be connected to network 140.

Computing system 110 represents any suitable computing system, such as one or more desktop computers, laptop computers, mainframes, servers, cloud computing systems, etc. capable of sending information to and receiving information from computing device 100 via a network, such as network 140. Computing system 110 hosts (or at least provides access to) information associated with one or more applications executable by computing device 100, such as user account information. In some examples, computing system 110 represents a cloud computing system that provides the application services via the cloud.

As shown in FIG. 1, computing system 110 includes tracking system module 112 and tracking device data 114. Tracking system module 112 may include one or more applications or services that provide tracking of computing devices and tracking devices. For instance, tracking system module 112 may obtain location data of tracking devices such as beacon 130 via network 140. Tracking system module 112 may obtain location data of beacon 130 via end-to-end encrypted location reports generated by computing device 100. Tracking system module 112 may provide the location data of one or more computing devices or tracking devices such as beacon 130 to computing devices such as owner device 120.

Tracking device data 114 may store tracking data of computing devices and/or tracking devices such as beacon 130. Tracking device data 114 may store data such as the last reported location of beacon 130, received hashed public keys of beacon 130, timestamps of reported interactions between beacon 130 and other computing devices, e.g., when computing device 100 reports the encrypted location, hashed public key, and other data associated with beacon 130. Tracking device data 114 may store location reports received from computing device 100 via network 140.

Tracking system module 112 may cause computing system 110 to provide end-to-end encrypted location reports to owner device 120 via network 140. Tracking system module 112 may provide end-to-end encrypted location reports to owner device 120 in response to a fetch location request from owner device 120. Tracking system module 112, based on a determination that beacon 130 is in the unwanted tracking prevention mode, may limit the ability of owner device 120 to obtain the location of beacon 130.

Owner device 120 represents a computing device to which beacon 130 is associated. Owner device 120 may be any suitable computing device such as a laptop, tablet computer, desktop, smartphone, smart watch, voice assistant device, or any other such computing device. Owner device 120 may conduct initial registration of beacon 130 to establish ownership of beacon 130. For example, owner device 120 may conduct a setup process with beacon 130 and provide data regarding beacon 130 to computing system 110 to associate beacon 130 with owner device 120. In addition, owner device 120 may periodically upload hashes of public keys generated by beacon 130 to computing system 110. Owner device 120 may upload anticipated public keys of beacon 130 for a period of time (e.g., the next four days, the next ten hours, etc.).

Owner device 120 may request updates to the location of beacon 130. Owner device 120 may provide fetch location requests to computing system 110 via network 140 to determine the location of beacon 130. Based on the location fetch request from owner device 120, computing system 110 may request an update to the location of beacon 130 from computing device 100.

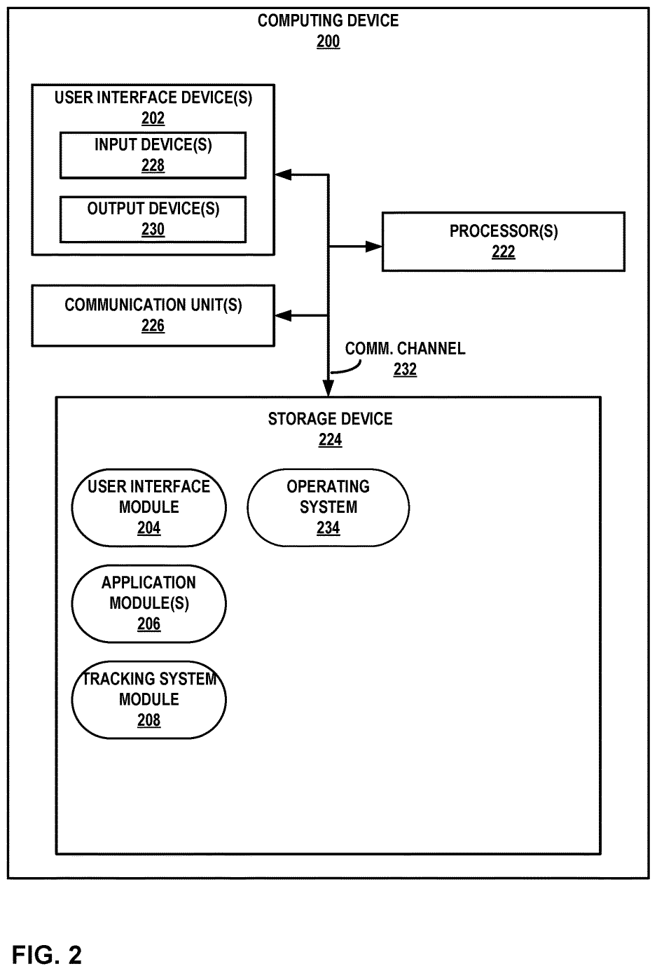

FIG. 2 is a block diagram illustrating an example computing device for protecting users from unwanted tracking, in accordance with one or more of the described techniques. Computing device 220 illustrated in FIG. 2 includes user interface devices 202, processors 222, communication units 226, comm channel 232, and storage device 224. As also shown in FIG. 2, storage device 224 may include a user interface module 204, application module 206, tracking system module 208, and operating system 234. FIG. 2 will be discussed in the context of FIG. 1.

In some examples, user interface devices 202 may be a presence-sensitive display configured to detect input (e.g., touch and non-touch input) from a user of respective computing device 200. User interface devices 202 may output information to a user in the form of a UI, which may be associated with functionality provided by computing device 200. Such UIs may be associated with computing platforms, operating systems, applications, and/or services executing at or accessible from computing device 200 (e.g., electronic message applications, chat applications, Internet browser applications, mobile or desktop operating systems, social media applications, electronic games, menus, and other types of applications).

Processors 222 may implement functionality and/or execute instructions within computing device 200. For example, processors 222 may receive and execute instructions that provide the functionality of user interface module 204, application module 206, tracking system module 208 (hereinafter “modules 204-208”), and operating system 234. These instructions executed by processors 222 may cause computing device 200 to store and/or modify information within storage device 224 during program execution. Processors 222 may execute instructions of modules 204-208 and operating system 234 to perform one or more operations. That is, modules 204-208 and operating system 234 may be operable by processors 222 to perform various functions described herein.

Storage device 224 of computing device 200 may store information for processing during operation of computing device 200 (e.g., computing device 200 may store data accessed by modules 204-208 and operating system 234 during execution at computing device 200). In some examples, storage device 224 may be a temporary memory, meaning that a primary purpose of storage device 224 is not long-term storage. Storage device 224 of computing device 200 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage device 224 may include one or more computer-readable storage media. Storage device 224 may store larger amounts of information than volatile memory of computing device 200 (e.g., random access memory (RAM) of computing device 200). Storage device 224 may further be configured for long-term storage of information as non-volatile memory space and retain information after power on/off cycles. Examples of non-volatile memories include magnetic hard disks, optical discs, floppy discs, flash memories, solid state drives, tape drives, forms of electrically programmable memories (EPROM), electrically erasable and programmable (EEPROM) memories, and other types of non-volatile memory. Storage device 224 may store program instructions and/or information associated with modules 204-208 and operating system 234.

Communication units 226 of computing device 200 may communicate with one or more external devices via one or more wired and/or wireless networks by transmitting and/or receiving network signals on the one or more networks. Examples of communication units 226 include a network interface card (e.g., an Ethernet card), an optical transceiver, a radio frequency transceiver, a GPS receiver, or any other type of device that can send and/or receive information. Other examples of communication units 226 may include short wave radios, cellular data radios, satellite data radios, wireless network radios, as well as universal serial bus (USB) controllers.

Input devices 228 of computing device 200 may receive input. Examples of input are tactile, audio, and video input. Input devices 228 of computing device 200, in one example, includes a presence-sensitive display, a fingerprint sensor, touch-sensitive screen, mouse, keyboard, voice responsive system, video camera, microphone or any other type of device for detecting input from a human or machine.

Input devices 228 may include one or more sensors. Numerous examples of sensors exist and include any input component configured to obtain environmental information about the circumstances surrounding computing device 200 and/or physiological information that defines the activity state and/or physical well-being of a user of computing device 200. In some examples, a sensor may be an input component that obtains physical position, movement, and/or location information of computing device 200. For instance, sensors may include one or more location sensors (e.g., GNSS components, WIFI components, cellular components), one or more temperature sensors, one or more motion sensors (e.g., multi-axial accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

Output devices 230 of computing device 200 may generate one or more outputs. Examples of outputs are tactile, audio, and video output. Output devices 230 of computing device 200, in one example, includes a presence-sensitive display, sound card, video graphics adapter card, speaker, liquid crystal display (LCD), or any other type of device for generating output to a human or machine.

Communication channels 232 (illustrated as “COMM. channel 232” in FIG. 2) may interconnect each of the components 202, 222, 224, and 226 for inter-component communications (physically, communicatively, and/or operatively). In some examples, communication channel 232 may include a system bus, a network connection, an inter-process communication data structure, or any other method for communicating data.

Computing device 200 may include operating system 234. Operating system 234 may control the operation of components of computing device 200. For example, operating system 234 may facilitate the communication of modules 204-208 with user interface devices 202, processors 222, storage device 224, and communication units 226. In some examples, operating system 234 may manage interactions between software applications (e.g., application module 206) and a user of computing device 200. Operating system 234 may have a kernel that facilitates interactions with underlying hardware of computing device 200 and provides a fully formed application space capable of executing a wide variety of software applications having secure partitions in which each of the software applications executes to perform various operations. In some examples, user interface module 204 may be considered a component of operating system 234.

Computing device 200 may include tracking system module 208. Tracking system module 208 may manage receiving and sending location reports of beacon 130 and other tracking devices. Tracking system module 208 may request a location of a tracking device, such as beacon 130 as illustrated in FIG. 1. Tracking system module 208 may cause computing device 200 to provide a request for the location of beacon 130 to an external computing device and/or system, such as computing system 110 as illustrated in FIG. 1 via communication units 226. For example, tracking system module 208 may provide a location request for a tracking device attached to a set of car keys lost by a user of computing device 200.

Tracking system module 208 may receive data regarding the location of beacon 130 from computing system 110. In addition, tracking system module 208 may receive date and time data in addition to the location data of beacon 130 (e.g., data indicating the date and time that beacon 130 was last seen at a particular location). Tracking system module 208, based on the receipt of the data from computing system 110, may cause output devices 230 to display a user interface illustrating the location of the tracking device.

Tracking system module 208 may cause output devices 230 to display a user interface that includes an alert regarding beacon 130. In an example, computing device 200 determines that beacon 130 is within a threshold proximity of computing device 200. Computing device 200 provides data regarding beacon 130 to computing system 110. Computing device 200 receives, from computing system 110, data that indicates the beacon is in an unwanted tracking prevention mode. Tracking system module 208, based on the data received from computing system 110, causes output devices 230 to display a user interface that includes an alert about beacon 130.

Tracking system module 208 may generate alerts for a user of computing device 200 based on one or more criteria. In an example, tracking system module 208 determines that computing system 200 has moved a threshold distance after originally detecting beacon 130. Tracking system module 208 determines that beacon 130 is still detected by computing device 200 and sends an indication to computing system 110. In addition, tracking system module 208 may cause computing device 200 to generate a graphical user interface that includes a visual, tactile, and/or haptic indication of an alert regarding beacon 130.

Tracking system module 208 enables a user of computing device 200 to store alerts regarding beacon 130 and to share the alerts with other computing devices. In an example, tracking system module 208 causes computing device 200 to display an alert regarding beacon 130. Tracking system module 208, in response to user input consistent with a request to save the alert, causes computing device 200 to store data of the alert in storage device 224. In another example, the user of computing device 200 wishes to share a series of alerts regarding beacon 130 with another computing device. Responsive to user input consistent with a request to share the alerts, tracking system module 208 causes computing device 200 to retrieve data regarding the alerts from storage device 224 and provide them to another computing device via communication units 226.

Tracking system module 208 additionally uses a determination of whether computing device 200 is stationary and connected to a WIFI network to determine whether to alert a user of computing device 200 to the presence of beacon 130. In an example, computing device 200 is stationary, connected to a known WIFI network, and detects beacon 130 within the proximity of computing device 200. Tracking system module 208, based on the determination that computing device 200 is stationary and connected to a known WIFI network, alerts the user to the presence of beacon 130. Tracking system module 208 may ignore connections to nomadic networks such as hotspots and/or use other considerations such as the security of the WIFI network to determine whether to alert a user of computing device 200.

Tracking system module 208 uses a determination that the user of computing device 200 has recently exited a personal vehicle to determine whether to alert the user of computing device 200 to the presence of beacon 130. Tracking system module 208 may use an activity recognition system to determine that the user of computing device 200 has recently exited their vehicle. In addition, tracking system module 208 may determine that the vehicle that the user has exited is the user's personal vehicle based on one or more factors such as whether computing device 200 was connected via BLUETOOTH to the vehicle's infotainment system, whether the location of computing device 200 while in the vehicle was consistent with location patterns of computing device 200 (e.g., whether the user was following a regularly-used route between their home and workplace), and other signals. Based on a determination that beacon 130 is still in proximity to computing device 200 after the user has exited their vehicle, tracking system module 208 may cause computing device 200 to provide an alert to the user of computing device 220.

Tracking system module 208 uses a determination of the time of day in determining whether to alert a user of computing device 200 to the presence of beacon 130. Tracking system module 208 may alert a user of computing device 200 to the presence of beacon 130 during a time of day that the user may be more vulnerable or when the presence of beacon 130 may be more concerning (e.g., the hours between 10 PM and 4 AM).

Tracking system module 208 may refrain from reporting the presence of beacon 130 to computing system 110 or alerting the user of computing device 200 in some circumstances. Tracking module 208 may refrain from reporting the presence of beacon 130 when computing device 200 is in a predetermined location of a plurality of predetermined locations. For example, the predetermined location may be the user's home address to maintain the privacy of the user of computing device 200. Tracking module 208 may additionally refrain from reporting the presence of beacon 130 at a location determined to be the home address of another individual, as it may be unlikely that a tracking device at a home location would be used to track the user of computing device 200. Further, tracking module 208 may enable computing device 200 to modify a predetermined location.

Tracking system module 208 may refrain from providing alerts about unwanted tracking by beacon 130 based on a determination that beacon 130 is located in a geofenced area. In an example, tracking system module 208 determines that computing device 200 and beacon 130 are currently located in an airport terminal. Due to the large number of possible trackers in an airport terminal (e.g., attached to luggage and away from their owners) a user of computing device 200 may become overwhelmed with a large number of alerts about unwanted tracking by beacon 130 and other tracking devices present in the geofenced area. Additionally, tracking system module 208 may refrain from providing an alert due to the likelihood that beacon 130 is being used to track a piece of luggage going to the same destination as computing device 200 rather than being used to track the user of computing device 200. Based on the determination that beacon 130 is located in the airport terminal, tracking system module 208 from causing computing device 200 to output an alert while beacon 130 remains in the geofenced area.

Tracking system module 208 may refrain from causing computing device 200 to output an alert when computing device 200 has deactivated airplane mode within a threshold period of time. In an example, computing device 200 has recently deactivated airplane mode, detected beacon 130 in proximity to computing device 200, and provided a location report of beacon 130 to tracking system module 208. Tracking system module 208, based on receiving the location report of beacon 130 in proximity to computing device 200, may refrain from causing computing device 200 to output alerts about beacon 130 for a predetermined period of time after computing device 200 has deactivated airplane mode. Tracking system module 208 may refrain from causing computing device 200 to output alerts about beacon 130 to avoid overwhelming a user of computing device 200 with alerts about tracking devices when the user is likely in an area with a high concentration of tracking devices, such as beacon 130, that are not tracking the user (e.g., an airport with many people using luggage trackers).

Tracking system module 208 may use a randomly generated 24-hour rotating client identification to implement privacy safeguards when causing computing device 200 to provide a location report of beacon 130 to computing system 110. Additionally, tracking system module 208 may encrypt the location reports provided to computing system 110 for further privacy protection.

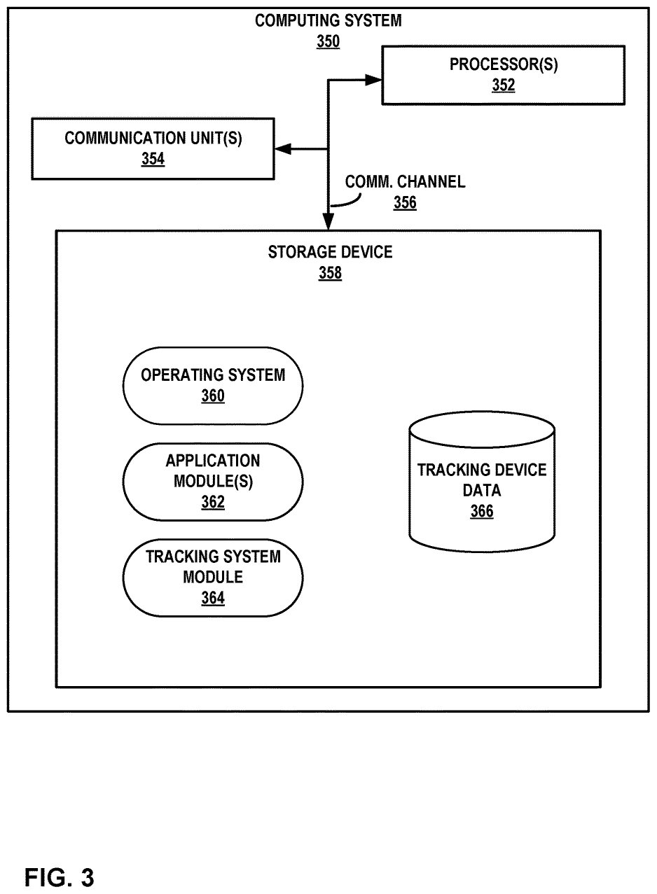

FIG. 3 is a block diagram illustrating an example computing system for protecting users from unwanted tracking, in accordance with one or more of the described techniques. As shown in FIG. 3, computing system 350 includes communication units 354, processors 352, communications channel 356 (illustrated as “COMM. CHANNEL 356” in FIG. 3), and storage device 358. Storage device 358 includes application modules 362, tracking system module 364, tracking device data 366, and operating system 360. For the purposes of clarity, FIG. 3 is discussed in the context of FIG. 1, with computing system 350 representing computing system 110.

Processors 352 may implement functionality and/or execute instructions of computing system 350. For example, processors 352 may receive and execute instructions that provide the functionality of modules 362, 364 and operating system 360. These instructions executed by processors 352 may cause computing system 350 to store and/or modify information within storage device 358 during program execution. Processors 352 may include one or more types of processors such as server processors, desktop processors, distributed compute nodes, and other types of processors and/or compute nodes. Processors 352 may execute instructions of modules 362, 364, and operating system 360 to perform one or more operations. That is, modules 362, 364, and operating system 360 may be operable by processors 352 to perform various functions described herein.

Storage device 358 may include one or more computer-readable storage media. Storage device 358 may be configured to store larger amounts of information than volatile memory. Storage device 358 may further be configured for long-term storage of information as non-volatile memory space and retain information after power on/off cycles. Examples of non-volatile memories include magnetic hard disks, optical discs, floppy discs, flash memories, or forms of electrically programmable memories (EPROM) or electrically erasable and programmable (EEPROM) memories. Storage device 358 may store program instructions and/or information associated with modules 362, 364, and operating system 360.

Communication units 354 of computing system 350 may communicate with one or more external devices via one or more wired and/or wireless networks by transmitting and/or receiving network signals on the one or more networks. Examples of communication units 354 include a network interface card (e.g., an Ethernet card), an optical transceiver, a radio frequency transceiver, a GPS receiver, or any other type of device that can send and/or receive information. Other examples of communication units 354 may include short wave radios, cellular data radios, satellite data radios, wireless network radios, as well as universal serial bus (USB) controllers.

Tracking system module 364 may obtain the locations of tracking devices such as beacon 130 illustrated in FIG. 1. Tracking system module 364 may receive indications from a sighting device, such as computing device 100 illustrated in FIG. 1, that a tracking device has been located. Tracking system module 364 may store the data regarding the located tracking device in tracking device data 366. Tracking system module 364 may receive data such as a public key, a hashed MAC address of the tracking device, metadata of the tracking device, and other data.

Tracking system module 364 stores data in tracking device data 366 regarding the owner of beacon 130. Tracking system module 364 may receive, from an owner device 120 such as owner device 120 as illustrated in FIG. 1, a registration of beacon 130 to owner device 120. Tracking system module 364 may associate a static ID of beacon 130 to owner device 120. Tracking system module 364 may store logged details of beacon 130 and other tracking devices in tracking device data 366.

Tracking system module 364 may alert a user of a computing device, such as computing device 100 as illustrated in FIG. 1, that they may be being tracked by beacon 130. Tracking system module 364 may, based on one or more criteria, provide an alert to computing device 100 that there may be an unwanted tracker such as beacon 130 in proximity to computing device 100. For example, tracking system module 364 may generate data regarding an alert. Tracking system module 264 may cause one or more components of computing system 350 to transmit the data regarding the alert to computing device 100.

Tracking system module 364 may determine whether to alert a user to the presence of a tracking device such as beacon 130 based on one or factors or contexts. For example, tracking system module 364 may obtain an indication that, after computing device 100 has moved, beacon 130 is still in the proximity of computing device 100 while computing device 100 is stationary and connected to WIFI. Tracking system module 364 uses the WIFI connection to determine that computing device 100 and by extension the user are at a known and fixed location (e.g., a proxy for home, work). Computing system 350 may filter out nomadic access points (e.g., security-enabled WIFI networks, WIFI hotspots, etc.) to determine whether computing device 100 is at an important location (e.g., home, work, etc.). Based on a determination that computing device 100 has recently moved to a known location based on the WIFI connection and that beacon 130 is still in proximity to computing device 100, tracking system module 364 may cause computing system 350 to provide an alert to computing device 100.

Tracking system module 364 may use time of day to determine whether to alert a user of computing device 100 to the presence of beacon 130. For example, tracking system module 364, detects that computing device 100, based on location data received from computing device 100, has stopped moving and that beacon 130 is still in proximity to computing device 100. Computing system 350, based on the determination that beacon 130 is still in proximity to computing device 100 during a specified time of day (e.g., 11 PM to 4 AM), provides an alert to computing device 100 regarding the presence of beacon 130.

Tracking system module 364 may provide an alert computing device 100 if computing device 100 has not moved for a threshold period of time and computing device 100 detects beacon 130 has remained in proximity to computing device 100. In an example, computing device 100 determines that, after computing device 100 has moved and then remained in a particular location for four hours, beacon 130 has remained in proximity to the user's computing device. Computing device 100 reports the detection of beacon 130 remaining in proximity to computing device 100. Tracking system module 364, based on the location data received from computing device 100 and the reported detection of beacon 130 by computing device 100, provides an alert regarding beacon 130 to computing device 100.

Tracking system module 364 may implement server-side protections against tracking abuse and limit the ability of owner device 120 to track the location of beacon 130 when beacon 130 is placed in the unwanted tracking prevention mode. Tracking system module 364 may limit how often owner device 120 is able to fetch the location of beacon 130 and limit how often tracking system module 364 updates the location of beacon 130 in tracking device data 366.

Tracking system module 364 may throttle requests for the location of beacon 130 while beacon 130 is in the unwanted tracking prevention mode. In an example, tracking system module 364 receives a fetch location request from owner device 120. As tracking device data 366 indicates that beacon 130 is currently in the unwanted tracking prevention mode, tracking system module 364, limits the frequency that owner device 120 can request the location of beacon 130 (e.g., once every 20 minutes for the first 24 hours, then every hour).

Tracking system module 364 may limit the frequency that tracking device data 366 is updated with the location of beacon 130 while beacon 130 is in the unwanted tracking prevention mode. In an example, while beacon 130 is in the unwanted tracking prevention mode, tracking system module 364 only updates tracking device data 366 at most once every hour regardless of how often tracking system module 364 receives location reports of beacon 130.

Tracking system module 364 may adjust the limitation on the frequency of updates on the location of beacon 130 that are provided to the owner of beacon 130 in response to a location report from a device associated with the owner of beacon 130. In an example, in response to a fetch location request, tracking system module 364 receives a location report of beacon 130 that a device associated with the owner of beacon 130 device contributed to. Tracking system module 364 may refrain from limiting how often tracking system module 364 responds to fetch location requests as one or more devices associated with the owner of the tracking device were in proximity to the tracking device.

Tracking system module 364 may limit the amount of data acquired from sighter devices such as computing device 100 to protect the privacy of the owner of computing device 100. Tracking system module 364 may delete existing location reports crowdsourced from devices such as computing device 100 when the tracking system module 364 receives a location report from a computing device associated with the user of owner device 120. Additionally, tracking system module 364 may only store new crowdsourced location reports if they are more recently generated than location reports generated by a computing device associated with the user of owner device 120. Tracking system module 364 may additionally limit the amount of data stored in tracking device data 366 by collecting hashed ephemeral identifications that include future hashed ephemeral identifications. Tracking system module 364 stores these hashed ephemeral identification and associates them with the stable identification of beacon 130, and synchronizes the expected future ephemeral identifications.

Tracking system module 364 may limit how often the location of beacon 130 is updated in tracking device data 366 using a timer and pseudorandom numbers associated with the location reports. In an example, tracking system module 364 receives a first location report of beacon 130 that includes a pseudorandom number. Computing device 100 may generate the pseudorandom number and associate it with the location report to identify the source device of the location report to tracking system module 364 while retaining the anonymity of computing device 100. Tracking system module 364 records the pseudorandom number and initiates a timer associated with the first location report that counts down from a predetermined period of time (e.g., 30 minutes, 2 hours, etc.). Tracking system module 364 receives a second location report of beacon 130 that includes the same pseudorandom number as the first location report. As the second location report includes the same pseudorandom number as the first location report, tracking system module 364 determines that the second location report originated from the same computing device as the first location report. Responsive to determining that the pseudorandom number of the first location report and the pseudorandom number of the second location report are the same, and that the timer associated with the pseudorandom number has not yet reached zero, tracking system module 364 rejects the second location report.

Tracking system module 364 may use end-to-end encryption to protect the privacy of users. For example, tracking system module 364 may receive, from a network of devices comprising the sighter network, an end-to-end encrypted location report with a network-specific asymmetric key that includes a rotating client identification, a hashed ephemeral identification, a time-stamp, and an end-to-end encrypted location. Tracking system module 364 sends the encrypted payload to a front-end server that decrypts the payload to identify the stable identification of beacon 130 and provides the crowdsourced report to owner device 120. Tracking system module 364 may use the end-to-end encryption of data exchanged between computing system 350, owner device 120, and/or computing device 100 to ensure confidentiality of the data and to prevent other parties from obtaining the data (e.g., the unencrypted data).

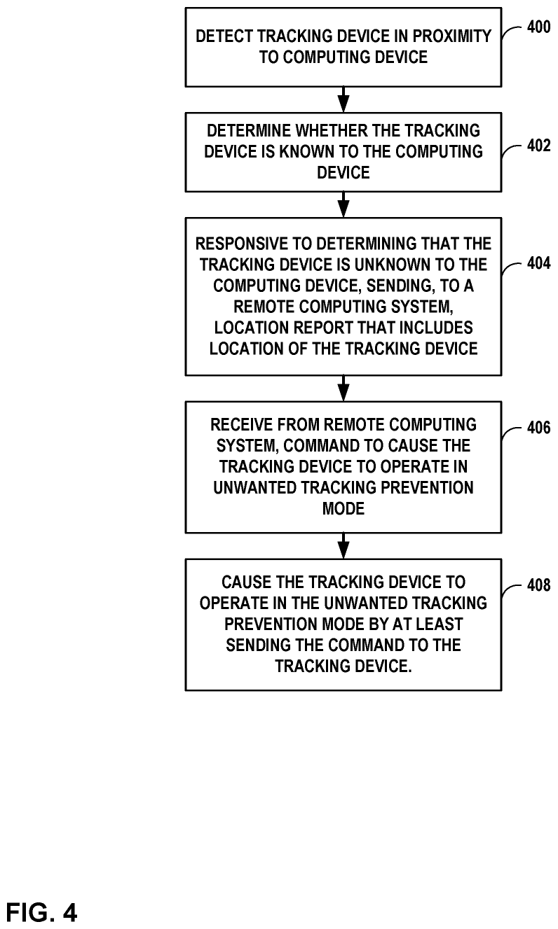

FIG. 4 is a flow chart illustrating an example operation on the peer-to-peer device tracking system for protecting users from unwanted tracking, in accordance with one or more of the techniques described herein. For the purposes of clarity, FIG. 4 is described in the context of FIG. 1.

In the example of FIG. 4, a computing device such as computing device 100, as illustrated in FIG. 1, detects a tracking device such as beacon 130, as illustrated in FIG. 1, in proximity to computing device 100 (400). Computing device 100 may detect beacon 130 as being in proximity to computing device 100 using one or more types of wireless communication such as BLUETOOTH, BLUETOOTH RSSI, WIFI, UWB, and other types of wireless communication.

Computing device 100 determines whether beacon 130 is known to computing device 100 (402). Computing device 100 may use a public key broadcasted by beacon 130 to determine whether beacon 130 is known to computing device 100. Computing device 100 may compare the identity of beacon 130 to one or more records of beacons maintained by computing device 100. Computing device 100 may provide a request regarding the ownership of beacon 130 to a remote computing device such as computing system 110 that maintains a record of tracking devices such as beacon 130 and associated owners to determine whether beacon 130 is known to computing device 100.

Computing device 100, based on a determination that beacon 130 is unknown to computing device 100, sends a location report to computing system 110 that includes the location of the tracking device (404). Computing device 100 may include the MAC address or other identifier of beacon 130 in the location report to computing system 110.

Computing device 100 receives a command from computing system 110 to cause beacon 130 to operate in an unwanted tracking prevention mode (406). Computing device 100 causes beacon 130 to operate in the unwanted tracking prevention mode by at least sending the command to beacon 130 (408). Responsive to receiving the command to operate in the unwanted tracking prevention mode, beacon 130 enters the unwanted tracking prevention mode. Beacon 130, while in the unwanted tracking prevention mode, may cease cycling MAC addresses that beacon 130 broadcasts to nearby devices such as computing device 100. Beacon 130 may additionally, while in the unwanted tracking prevention mode, broadcast packets that include a bit associated with beacon 130 being in the unwanted tracking prevention mode.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Example 1: A method includes detecting, by a computing device, a tracking device in proximity to the computing device; determining, by the computing device, whether the tracking device is known to the computing device; responsive to determining that the tracking device is unknown to the computing device, sending, by the computing device and to a remote computing system, a location report that includes a location of the tracking device; receiving, by the computing device and from the remote computing system, a command to cause the tracking device to operate in an unwanted tracking prevention mode; and causing, by the computing device, the tracking device to operate in the unwanted tracking prevention mode by at least sending the command to the tracking device.

Example 2: The method of example 1, further includes responsive to determining that the tracking device is unknown to the computing device, determining, by the computing device, whether the computing device has moved a threshold distance from the location of the tracking device included in the location report; responsive to determining that the computing device has moved the threshold distance, determining, by the computing device, whether the tracking device is still detected; and responsive to determining that the tracking device is still detected, sending, by the computing device and to the remote computing system, an indication that the tracking device is still detected.

Example 3: The method of example 1, further includes determining, by the computing device, whether to alert a user of the computing device that the tracking device is in proximity to the computing device; responsive to determining to alert the user of the computing device that the tracking device is in proximity to the computing device, outputting, by the computing device, a visual, audio, or haptic indicator of an alert to the user of the computing device.

Example 4: The method of example 2, wherein determining whether to alert the user of the computing device that the tracking device is in proximity to the computing device comprises determining that the computing device is stationary and connected to a WIFI network.

Example 5: The method of example 3, further includes determining, by the computing device, that the user of the computing device has recently exited a personal vehicle; and responsive to determining that the user of the computing device has recently exited the personal vehicle, outputting, by the computing device, a visual, audio, or haptic indicator of the alert.

Example 6: The method of example 3, further includes determining, by the computing device, that the tracking device is in proximity to the computing device during a predetermined time of day; and responsive to determining that the tracking device is in proximity to the computing device during the predetermined time of day, outputting, by the computing device, a visual, audio, or haptic indicator of the alert.

Example 7: The method of example 1, further includes receiving, by the computing device and from the tracking device, a hashed value generated using a rotating public key, wherein the hashed value is applied to a rotating unique identifier of the tracking device, wherein the location report further includes the hashed value; and encrypting, by the computing device, the location report prior to sending to the remote computing system.

Example 8: The method of example 1, further includes determining, by the computing device, that the computing device is located near a predetermined location of a plurality of predetermined locations; and refraining, by the computing device, from sending the location report to the remote computing system.

Example 9: The method of example 8, further comprising modifying, by the computing device, the predetermined location.

Example 10: The method of example 8, further includes determining, by the computing device, whether the computing device is located within a particular geofenced region of the plurality of predetermined locations; and responsive to determining that the computing device is located within the particular geofenced region, refraining, by the computing device from sending the location report to the remote computing system.

Example 11: The method of example 1, further includes disabling, by the computing device, an airplane mode of the computing device; and refraining, by the computing device, from sending the location report to the remote computing system for a predetermined period of time following the disabling of the airplane mode.

Example 12: A computing device includes a memory; and one or more programmable processors, configured to: detect a tracking device in proximity to the computing device; determine whether the tracking device is known to the computing device; responsive to determining that the tracking device is unknown to the computing device, send to a remote computing system, a location report that includes a location of the tracking device; receive, from the remote computing system, a command to cause the tracking device to operate in an unwanted tracking prevention mode; and cause the tracking device to operate in the unwanted tracking prevention mode by at least sending the command to the tracking device.

Example 13: The computing device of example 12, wherein the one or more programmable processors are further configured to: responsive to determining that the tracking device is unknown to the computing device, determine whether the computing device has moved a threshold distance from the location of the tracking device included in the location report; responsive to determining that the computing device has moved the threshold distance, determine whether the tracking device is still detected; and responsive to determining that the tracking device is still detected, send, to the remote computing system, an indication that the tracking device is still detected.

Example 14: The computing device of example 12, wherein the one or more programmable processors are further configured to: determine whether to alert a user of the computing device that the tracking device is in proximity to the computing device; and responsive to determining to alert the user of the computing device that the tracking device is in proximity to the computing device output the graphical user interface that includes a visual, audio, or haptic indicator of the alert.

Example 15: The computing device of example 14, wherein determining whether to alert a user of the computing device that the tracking device is in proximity to the computing device comprises determining that the computing device is stationary and connected to a WIFI network.

Example 16: The computing device of example 14, wherein the one or more programmable processors are further configured to: determine that a user of the computing device has recently exited a personal vehicle; and responsive to determining that the user of the computing device has recently exited the personal vehicle, output a visual, audio, or haptic indicator of the alert.

Example 17: The computing device of example 14, wherein the one or more programmable processors are further configured to: determine that the tracking device is in proximity to the computing device during a predetermined time of day; and responsive to determining that the tracking device is in proximity to the computing device during the predetermined time of day, output a visual, audio, or haptic indicator of the alert.

Example 18: The computing device of example 12, wherein the one or more programmable processors are further configured to: receive, from the tracking device, a hashed value generated using a rotating public key, wherein the hashed value is applied to a rotating unique identifier of the tracking device, wherein the location report further includes the hashed value; and encrypt the location report prior to sending to the remote computing system.

Example 19: The computing device of example 12, wherein the one or more programmable processors are further configured to: determine that the computing device is located near a predetermined location of a plurality of predetermined locations; and refrain from sending the location report to the remote computing system.

Example 20: The computing device of example 19, wherein the one or more programmable processors are further configured to: determine whether the computing device is located within a particular geofenced region of the plurality of predetermined regions; and responsive to determining that the computing device is located within the particular geofenced region, refrain from sending the location report to the remote computing system.

Example 22: The computing device of example 12, wherein the one or more programmable processors are further configured to: disable an airplane mode of the computing device; and refrain from sending the location report to the remote computing system for a predetermined period of time following the disabling of the airplane mode.

Example 23: A non-transitory computer-readable medium, encoded with instructions that, when executed, cause one or more processors of a computing device to: detect a tracking device in proximity to the computing device; determine whether the tracking device is known to the computing device; responsive to determining that the tracking device is unknown to the computing device, send to a remote computing system, a location report that includes a location of the tracking device; receive, from the remote computing system, a command to cause the tracking device to operate in an unwanted tracking prevention mode; and cause the tracking device to operate in the unwanted tracking prevention mode by at least sending the command to the tracking device.

Example 24: The non-transitory computer-readable medium of example 23, wherein the instructions further cause the one or more processors to: responsive to determining that the tracking device is unknown to the computing device, determine whether the computing device has moved a threshold distance from the location of the tracking device included in the location report; responsive to determining that the computing device has moved the threshold distance, determine whether the tracking device is still detected; and responsive to determining that the tracking device is still detected, send, to the remote computing system, an indication that the tracking device is still detected.

Example 25: The non-transitory computer-readable medium of example 23, wherein the instructions further cause the one or more processors to: determine whether to alert a user of the computing device that the tracking device is in proximity to the computing device; and responsive to determining to alert the user of the computing device that the tracking device is in proximity to the computing device output the graphical user interface that includes a visual, audio, or haptic indicator of the alert.

Example 26: The non-transitory computer-readable medium of example 25, wherein determining whether to alert a user of the computing device that the tracking device is in proximity to the computing device comprises determining that the computing device is stationary and connected to a WIFI network.

Example 27: The non-transitory computer-readable medium of example 25, wherein to the instructions further cause the one or more processors to: determine that a user of the computing device has recently exited a personal vehicle receive an alert that the tracking device is in proximity to the computing device; and responsive to determining that the user of the computing device has recently exited the personal vehicle, output a visual, audio, or haptic indicator of the alert.

Example 28: The non-transitory computer-readable medium of example 25, wherein the instructions further cause the one or more processors to: determine that the tracking device is in proximity to the computing device during a predetermined time of day; and responsive to determining that the tracking device is in proximity to the computing device during the predetermined time of day, output a visual, audio, or haptic indicator of the alert.

Example 29: The non-transitory computer-readable medium of example 23, wherein the instructions further cause the one or more processors to: receive, from the tracking device, a hashed value generated using a rotating public key, wherein the hashed value is applied to a rotating unique identifier of the tracking device, wherein the location report further includes the hashed value; and encrypt the location report prior to sending to the remote computing system.

Example 30: The non-transitory computer-readable medium of example 23, wherein the instructions further cause the one or more processors to: determine that the computing device is located near a predetermined location of a plurality of predetermined locations; and refrain from reporting the tracking device to the remote computing system.

Example 31: The non-transitory computer-readable medium of example 30, wherein the instructions cause the one or more processors to modify the predetermined location.

Example 32: The non-transitory computer-readable medium of example 30, wherein the instructions further cause the one or more processors to: determine whether the computing device is located within a particular geofenced region of the plurality of predetermined locations; and responsive to determining that the computing device is located with the particular geofenced region, refraining from sending the location report to the remote computing system.

Example 33: The non-transitory computer-readable medium of example 23, wherein the instructions further cause the one or more processors to: disable an airplane mode of the computing device; and refrain from sending the location report to the remote computing system for a predetermined period of time following the disabling of the airplane mode.

Example 34: A computing system includes a memory; and one or more programmable processors, configured to: receive an indication that a sighter device from a plurality of sighter devices has detected a tracking device unknown to the sighter device, wherein the sighter device is a computing device other than an owner device associated with the tracking device; determine whether to place the tracking device into an unwanted tracking prevention mode; and responsive to determining to place the tracking device into the unwanted tracking prevention mode, send, to the sighter device, a command to cause the tracking device to operate in the unwanted tracking prevention mode.

Example 35: The computing system of example 34, wherein the one or more programmable processors are further configured to: receive a plurality of location reports of the tracking device; determine which location reports of the plurality of location reports were generated by the owner device; and store the location reports generated by the owner device.

Example 36: The computing system of example 35, wherein the one or more programmable processors are configured to: determine whether a location report of the plurality of location reports was generated by the sighter device more recently than the most recent location report generated by the owner device; and responsive to determining that the location report generated by the sighter device was generated more recently than the most recent location report generated by the owner device, store the location report generated by the sighter device.

Example 37: The computing system of example 36, wherein the one or more programmable processors are further configured to: responsive to determining that a location report has been received from the owner device that is more recent than the location report generated by the sighter device, delete the location report generated by the sighter device.

Example 38: The computing system of example 34, wherein the one or more programmable processors are further configured to: receive a fetch location request from the owner device; determine whether the tracking device has been reported by any of the sighter devices from the plurality of sighter devices since the owner device last reported the tracking device; and responsive to determining that the tracking device has been reported by the any of the sighter devices of the plurality of sighter devices since the owner device last reported the tracking device, determine a period of time to wait before fetching the location of the tracking device.

Example 39: The computing system of example 38, wherein determine a period of time further includes: determine an amount of time that has elapsed since the owner device last reported the tracking device; and increasing the period of time based on the amount of time that has elapsed since the owner device last reported the tracking device.

Example 40: The computing system of example 34, wherein the one or more programmable processors are further configured to: obtain, from a sighter device, a location report comprising an encrypted payload; decrypt the encrypted payload; identify a stable identifier of the tracking device; and provide a location report of the tracking device to an owner device associated with the stable identifier of the tracking device.

Example 41: The computing system of example 35, wherein the one or more programmable processors are further configured to: receive, from the sighter device, a first location report of the tracking device, wherein the first location report includes a pseudorandom number; record the pseudorandom number of the first location report; initiate a timer associated with the first location report, wherein the timer counts down from a predetermined period of time; receive a second location report of the tracking device, wherein the second location report includes the pseudorandom number; and responsive to determining that the pseudorandom number of the first location report is the same as the pseudorandom number of the second location report and that the timer associated with the first location report has not reached zero, reject the second location report.

Example 42: The computing system of example 34, wherein the one or more programmable processors are further configured to log one or more details of the tracking device.

Example 43: The computing system of example 34, wherein the one or more programmable processors are configured to: receive a location report of the tracking device; determine that a computing device associated with the owner device contributed to the location report; and responsive to determining that the computing device associated with the owner device contributed to the location report, send, to the owner device, the location report.

Example 44: The computing system of example 34, wherein the one or more programmable processors are further configured to: receive a plurality of hashed ephemeral identifiers each associated with a respective tracking device from a plurality of tracking devices; associate each hashed ephemeral identification with a stable identifier associated with the respective tracking device from the plurality of tracking devices; and synchronize the plurality of hashed ephemeral identifications to determine expected ephemeral identifications of the plurality of tracking devices.

Example 45: A method includes receiving, by a computing system, an indication that a sighter device of a plurality of sighter devices has detected a tracking device unknown to the sighter device, wherein the sighter device is a computing device other than an owner device associated with the tracking device; determining, by the computing system and based on one or more factors, whether to place the tracking device into an unwanted tracking prevention mode; and responsive to determining to the place the tracking device into the unwanted tracking prevention mode, sending, by the computing system and to the tracking device, a command to cause the tracking device to transition into operating in the unwanted tracking prevention mode.

Example 46: The method of example 45, further includes receiving, by the computing system, a plurality of location reports of the tracking device; determining, by the computing system, which location reports of the plurality of location reports were generated by the owner device; and storing, by the computing system, the location reports generated by the owner device.

Example 47: The method of example 46, further includes determining, by the computing system, whether a location report of the plurality of location reports was generated by the sighter device more recently than the most recent location report generated by the owner device; and responsive to determining that the location report generated by the sighter device was generated more recently than the most recent location report generated by the owner device, storing, by the computing system, the location report generated by the sighter device.

Example 48: The method of example 47, further includes, responsive to determining that a location report has been received from the owner device that is more recent than the location report generated by the sighter device, deleting, by the computing system the location report generated by the sighter device.

Example 49: The method of example 45, further includes receiving, by the computing system a fetch location request from the owner device; determining, by the computing system, whether the tracking device has been reported by any of the sighter devices from the plurality of sighter devices since the owner device last reported the tracking device; and responsive to determining that the tracking device has been reported by the any of the sighter devices of the plurality of sighter devices since the owner device last reported the tracking device, determining, by the computing system a period of time to wait before fetching the location of the tracking device.

Example 50: The method of example 49, wherein determining a period of time further includes: determining an amount of time that has elapsed since the owner device last reported the tracking device as an elapsed time; and increasing the period of time based on the amount of time that has elapsed time since the owner device last reported the tracking device.

Example 51: The method of example 45, further includes obtaining, by the computing system and from a sighter device, a location report comprising an encrypted payload; decrypting, by the computing system the encrypted payload; identifying, by the computing system a stable identifier of the tracking device; and providing, by the computing system a location report of the tracking device to an owner device associated with the stable identifier of the tracking device.

Example 52: The method of example 45, further includes receiving, by the computing system and from the sighter device, a first location report of the tracking device, wherein the first location report includes a pseudorandom number; recording, by the computing system, the pseudorandom number of the first location report; initiating, by the computing system, a timer associated with the first location report, wherein the timer counts down from a predetermined period of time; receiving, by the computing system a second location report of the tracking device, wherein the second location report includes the pseudorandom number; and responsive to determining that the pseudorandom number of the first location report being the same as the pseudorandom number of the second location report and that the timer associated with the first location report has not reached zero, rejecting, by the computing system the second location report.

Example 53: The method of example 45, further comprising logging, by the computing system, one or more details of the tracking device.

Example 54: The method of example 45, further includes receiving, by the computing system, a location report of the tracking device; determining, by the computing system, that a computing device associated with the owner device contributed to the location report; and responsive to determining that the computing device associated with the owner device contributed to the location report, sending, to the owner device, the location report.

Example 55: The method of example 45, further includes receiving, by the computing system, a plurality of hashed ephemeral identifiers each associated with a respective tracking device from a plurality of tracking devices; associating, by the computing system, each hashed ephemeral identifier with a stable identifiers associated with the respective tracking device of the plurality of tracking devices; and synchronizing, by the computing system, the plurality of hashed ephemeral identifiers to determine expected ephemeral identifiers of the plurality of tracking devices.

Example 56: A non-transitory computer-readable medium encoded with instructions that, when executed, cause one or more processors to: receive an indication that a sighter device from a plurality of sighter devices has detected a tracking device unknown to the sighter device, wherein the sighter device is a computing device other than an owner device associated with the tracking device; determine whether to place the tracking device into an unwanted tracking prevention mode; and responsive to determining to place the tracking device into the unwanted tracking prevention mode, send, to the sighter device, a command to cause the tracking device to operate in the unwanted tracking prevention mode.

Example 57: The non-transitory computer-readable medium of example 56, wherein the instructions further cause the one or more processors to: receive a plurality of location reports of the tracking device; determine which location reports of the plurality of location reports were generated by the owner device; and store the location reports generated by the owner device.

Example 58: The non-transitory computer-readable medium of example 57, wherein the instructions further cause the one or more processors to: determine whether a location report of the plurality of location reports was generated by the sighter device more recently than the most recent location report generated by the owner device; and responsive to determining that the location report generated by the sighter device was generated more recently than the most recent location report generated by the owner device, store the location report generated by the sighter device.

Example 59: The non-transitory computer-readable medium of example 58, wherein the instructions further cause the one or more processors to: responsive to determining that a location report has been received from the owner device that is more recent than the location report generated by the sighter device, delete the location report generated by the sighter device.

Example 60: The non-transitory computer-readable medium of example 56, wherein the instructions further cause the one or more processors to: receive a fetch location request from the owner device; determine whether the tracking device has been reported by any of the sighter devices from the plurality of sighter devices since the owner device last reported the tracking device; and responsive to determining that the tracking device has been reported by the any of the sighter devices of the plurality of sighter devices since the owner device last reported the tracking device, determine a period of time to wait before fetching the location of the tracking device.

Example 61: The non-transitory computer-readable medium of example 60, wherein the instructions further cause the one or more processors to: determine an amount of time that has elapsed since the owner device last reported the tracking device; and increasing the period of time based on the amount of time that has elapsed since the owner device last reported the tracking device.

Example 62: The non-transitory computer-readable medium of example 56, wherein the instructions further cause the one or more processors to: obtain, from a sighter device, a location report comprising an encrypted payload; decrypt the encrypted payload; identify a stable identifier of the tracking device; and provide a location report of the tracking device to an owner device associated with the stable identifier of the tracking device.

Example 63: The non-transitory computer-readable medium of example 57, wherein the instructions further cause the one or more processors to: receive, from the sighter device, a first location report of the tracking device, wherein the first location report includes a pseudorandom number; record the pseudorandom number of the first location report; initiate a timer associated with the first location report, wherein the timer counts down from a predetermined period of time; receive a second location report of the tracking device, wherein the second location report includes the pseudorandom number; and responsive to determining that the pseudorandom number of the first location report is the same as the pseudorandom number of the second location report and that the timer associated with the first location report has not reached zero, reject the second location report.

Example 64: The non-transitory computer-readable medium of example 56, wherein the instructions further cause the one or more processors to log one or more details of the tracking device.

Example 65: The non-transitory computer-readable medium of example 56, wherein the instructions further cause the one or more processors to: receive a location report of the tracking device; determine that a computing device associated with the owner device contributed to the location report; and responsive to determining that the computing device associated with the owner device contributed to the location report, send, to the owner device, the location report.

Example 66: The non-transitory computer-readable medium of example 56, wherein the instructions further cause the one or more processors to: receive a plurality of hashed ephemeral identifiers each associated with a respective tracking device from a plurality of tracking devices; associate each hashed ephemeral identification with a stable identifier associated with the respective tracking device from the plurality of tracking devices; and synchronize the plurality of hashed ephemeral identifications to determine expected ephemeral identifications of the plurality of tracking devices.

Example 67: A computer program product configured to store instructions that, when executed, cause one or more processors to: detect a tracking device in proximity to the computing device; determine whether the tracking device is known to the computing device; responsive to determining that the tracking device is unknown to the computing device, send to a remote computing system, a location report that includes a location of the tracking device; receive, from the remote computing system, a command to cause the tracking device to operate in an unwanted tracking prevention mode; and cause the tracking device to operate in the unwanted tracking prevention mode by at least sending the command to the tracking device.

Example 68: A computer program product configured to store instructions that, when executed, cause one or more processors to: receive an indication that a sighter device from a plurality of sighter devices has detected a tracking device unknown to the sighter device, wherein the sighter device is a computing device other than an owner device associated with the tracking device; determine whether to place the tracking device into an unwanted tracking prevention mode; and responsive to determining to place the tracking device into the unwanted tracking prevention mode, send, to the sighter device, a command to cause the tracking device to operate in the unwanted tracking prevention mode.

1. A method comprising:
detecting, by a computing device, a tracking device in proximity to the computing device;
determining, by the computing device, whether the tracking device is known to the computing device;
responsive to determining that the tracking device is unknown to the computing device, sending, by the computing device and to a remote computing system, a location report that includes a location of the tracking device;
receiving, by the computing device and from the remote computing system, a command to cause the tracking device to operate in an unwanted tracking prevention mode; and
causing, by the computing device, the tracking device to operate in the unwanted tracking prevention mode by at least sending the command to the tracking device.

2. The method of claim 1, further comprising:
responsive to determining that the tracking device is unknown to the computing device, determining, by the computing device, whether the computing device has moved a threshold distance from the location of the tracking device included in the location report;
responsive to determining that the computing device has moved the threshold distance, determining, by the computing device, whether the tracking device is still detected; and
responsive to determining that the tracking device is still detected, sending, by the computing device and to the remote computing system, an indication that the tracking device is still detected.

3. The method of claim 1, further comprising:
determining, by the computing device, whether to alert a user of the computing device that the tracking device is in proximity to the computing device; and
responsive to determining to alert the user of the computing device that the tracking device is in proximity to the computing device, outputting, by the computing device, a visual, audio, or haptic indicator of an alert to the user of the computing device.

4. The method of claim 2, wherein determining whether to alert a user of the computing device that the tracking device is in proximity to the computing device comprises determining that the computing device is stationary and connected to a WIFI network.

5. The method of claim 3, further comprising:
determining, by the computing device, that the user of the computing device has recently exited a personal vehicle; and
responsive to determining that the user of the computing device has recently exited the personal vehicle, outputting, by the computing device, a visual, audio, or haptic indicator of the alert.

6. The method of claim 3, further comprising:
determining, by the computing device, that the tracking device is in proximity to the computing device during a predetermined time of day; and
responsive to determining that the tracking device is in proximity to the computing device during the predetermined time of day, outputting, by the computing device, a visual, audio, or haptic indicator of the alert.

7. The method of claim 1, further comprising:
receiving, by the computing device and from the tracking device, a hashed value generated using a rotating public key, wherein the hashed value is applied to a rotating unique identifier of the tracking device, wherein the location report further includes the hashed value; and
encrypting, by the computing device, the location report prior to sending to the remote computing system.

8. The method of claim 1, further comprising:
determining, by the computing device, that the computing device is located near a predetermined location from a plurality of predetermined locations; and
refraining, by the computing device, from sending the location report to the remote computing system.

9. The method of claim 8, further comprising:
determining, by the computing device, whether the computing device is located within a particular geofenced region of the plurality of predetermined locations; and
responsive to determining that the computing device is located within the particular geofenced region, refraining, by the computing device from sending the location report to the remote computing system.

10. The method of claim 1, further comprising:
disabling, by the computing device, an airplane mode of the computing device; and
refraining, by the computing device, from sending the location report to the remote computing system for a predetermined period of time following the disabling of the airplane mode.

11. A computing device, comprising:
a memory; and
one or more programmable processors in communication with the memory, and configured to:
detect a tracking device in proximity to the computing device;
determine whether the tracking device is known to the computing device;
responsive to determining that the tracking device is unknown to the computing device, send to a remote computing system, a location report that includes a location of the tracking device;
receive, from the remote computing system, a command to cause the tracking device to operate in an unwanted tracking prevention mode; and
cause the tracking device to operate in the unwanted tracking prevention mode by at least sending the command to the tracking device.

12. The computing device of claim 11, wherein the one or more programmable processors are further configured to:
responsive to determining that the tracking device is unknown to the computing device, determine whether the computing device has moved a threshold distance from the location of the tracking device included in the location report;
responsive to determining that the computing device has moved the threshold distance, determine whether the tracking device is still detected; and
responsive to determining that the tracking device is still detected, send, to the remote computing system, an indication that the tracking device is still detected.

13. The computing device of claim 11, wherein the one or more programmable processors are further configured to:
determine whether to alert a user of the computing device that the tracking device is in proximity to the computing device; and
responsive to determining to alert the user of the computing device that the tracking device is in proximity to the computing device, output a graphical user interface that includes a visual, audio, or haptic indicator of an alert.

14. The computing device of claim 11, wherein the one or more programmable processors are further configured to:
receive, from the tracking device, a hashed value generated using a rotating public key, wherein the hashed value is applied to a rotating unique identifier of the tracking device, wherein the location report further includes the hashed value; and
encrypt the location report prior to sending to the remote computing system.

15. A non-transitory computer-readable medium, encoded with instructions that, when executed, cause one or more processors of a computing device to:
detect a tracking device in proximity to the computing device;
determine whether the tracking device is known to the computing device;
responsive to determining that the tracking device is unknown to the computing device, send to a remote computing system, a location report that includes a location of the tracking device;
receive, from the remote computing system, a command to cause the tracking device to operate in an unwanted tracking prevention mode; and
cause the tracking device to operate in the unwanted tracking prevention mode by at least sending the command to the tracking device.

16. (canceled)

17. The computing device of claim 13, wherein the one or more programmable processors are further configured to:
determine that the tracking device is in proximity to the computing device during a predetermined time of day; and
responsive to determining that the tracking device is in proximity to the computing device during the predetermined time of day, output a visual, audio, or haptic indicator of the alert.

18. The non-transitory computer-readable medium of claim 15, wherein the instructions further cause the one or more processors to:
responsive to determining that the tracking device is unknown to the computing device, determine whether the computing device has moved a threshold distance from the location of the tracking device included in the location report;
responsive to determining that the computing device has moved the threshold distance, determine whether the tracking device is still detected; and
responsive to determining that the tracking device is still detected, send, to the remote computing system, an indication that the tracking device is still detected.

19. The non-transitory computer-readable medium of claim 15, wherein the instructions further cause the one or more processors to:
determine whether to alert a user of the computing device that the tracking device is in proximity to the computing device; and
responsive to determining to alert the user of the computing device that the tracking device is in proximity to the computing device, output a graphical user interface that includes a visual, audio, or haptic indicator of an alert.

20. The non-transitory computer-readable medium of claim 19, wherein the instructions further cause the one or more processors to:
determine that the user of the computing device has recently exited a personal vehicle; and
responsive to determining that the user of the computing device has recently exited the personal vehicle, output a visual, audio, or haptic indicator of the alert.

21. The non-transitory computer-readable medium of claim 15, wherein the instructions further cause the one or more processors to:
receive, from the tracking device, a hashed value generated using a rotating public key, wherein the hashed value is applied to a rotating unique identifier of the tracking device, wherein the location report further includes the hashed value; and
encrypt the location report prior to sending to the remote computing system.
